(19) United States
(12) Patent Application Publication
(10) Pub. No.: US 2020/0311620 A1
(43) Pub. Date: Oct. 1, 2020

(54) Multipark Valet Parking Application

(71) Applicant: Marcus Wells, Arlington, TX (US)

(72) Inventor: Marcus Wells, Arlington, TX (US)

(21) Appl. No.: 16/813,312

(22) Filed: Mar. 9, 2020

Related U.S. Application Data
(60) Provisional application No. 62/825,133, filed on Mar. 28, 2019.

(51) Int. Cl. G06Q 10/02; G06Q 20/08; G06Q 50/30; G06Q 30/06; G06Q 10/00; G06Q 10/06

(52) U.S. Cl. CPC G06Q 10/02; G06Q 20/0855; G06Q 50/30; G01S 19/51; G06Q 10/20; G06Q 10/06312; G06Q 2240/00; G06Q 30/0645

(57) ABSTRACT

A computer program product and a mobile application are disclosed for managing a valet service for a vehicle, comprising negotiating a drop-off and a pickup of the vehicle from a selected valet provider, reserving a valet parking of the vehicle via the selected valet provider, transacting a fee for the valet parking paid from a user to the valet provider and determining associated services for the vehicle while parked. Additionally, reserving a new valet reservation via a GPS location of the vehicle, a location of a selected valet provider and a drop-off and pickup time are disclosed. Furthermore, determining associated services for the vehicle while parked further includes renting the vehicle to a third party for a time the vehicle is to be parked, washing or detailing the vehicle and performing mechanical and other repairs are included. Yet picking up the vehicle from a third party vehicle renter is disclosed.

### CROSS REFERENCE TO PROVISIONAL

This application claims priority to the Provisional Patent Application 62825133 titled, ‘Multipark Valet Parking Application,’ filed Mar. 28, 2019 by Marcus Wells referenced herein in its entirety.

### BACKGROUND OF THE INVENTION

Using valet parking services can be a lifesaver when in a rush to attend a special affair or simply to have a fun night out. Valet parking services relieve the stress of finding available parking in exchange for a fee.

### BRIEF DESCRIPTION OF DRAWINGS

FIG. 1 depicts a first flow chart of the multipark valet parking application in accordance with the present invention.

FIG. 2 depicts a second flow chart of the multipark valet parking application in accordance with the present invention.

FIG. 3 depicts a third flow chart of the multipark valet parking application in accordance with the present invention.

FIG. 4 is a flow chart of steps of a mobile application and a method for managing a valet parking of a vehicle per a multipark valet in accordance with a present embodiment of the disclosure.

FIG. 5 is a block diagram of component modules for managing a valet parking of a vehicle per a multipark valet in accordance with an embodiment of the present disclosure.

Throughout the description, same reference numbers may be used to identify same or similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the term ‘valet parking,’ refers not only to automobile parking but also to boat parking and vessel parking as well. Similarly, the term ‘car,’ and ‘vehicle,’ and ‘automobile,’ are used synonymously throughout the present disclosure. Terms associated therewith including ‘mechanical repair, wash/detail, parking space, drop off and pickup,’ refer to boats, cars, automobiles, vehicles, vessels, trucks, planes and indeed any conveyance for a person or a living thing that is autonomously, automatically and manually controlled for operation, maintenance and temporary and long term storage.

The disclosed mobile application is an online platform where a user searches for nearby valet providers and sends a request to park a car. From another screen of the mobile application, a valet provider accepts the request and allows the user to park his or her vehicle. Accepting and rejecting any request is managed through a unique code assigned at time of using the mobile application. Payment for each booking or use is also managed through Google Pay® or Apple Pay®. The user and the valet provider is given an option to purchase a subscription plan to become a premium member and have access to other services associated with the vehicle such as to and including car washing, car detailing, car repair, and car rental to other users.

Based on a user's location, a user is able to view available parking spaces on a map. Upon tapping any valet provider, the application shows parking services, price and distance from the user's location. Upon tapping a button associated with any of the above, the user books a parking space and associated services.

Valet space providers submit an initial application which an administrator of the disclosed mobile app then approves for participation. The valet provider accepts or rejects a user's booking request and submits a price or fee amount to the user for contract. A user logging into the disclosed mobile app for the first time will be showed valet providers in his or her zipcode. The user gives permission to the app to disclose his or her location for the application to further disclose valet parking providers.

An extend booking and a delayed booking features are available to the user to modify the terms of his or her agreement with the valet provider. Users are also given an opportunity to rate and rank a valet provider. A user account is created wherein a summary of past transactions, present transactions and even future transactions are provided in the mobile application.

The main purpose of MultiPark is to present an app (application) that facilitates a smoother and simpler valet and parking experience for guests when attending events. With the advancement of technology, there are a few parking and ride-sharing services apps on the market. However, there is still room for improvements to perfect valet services and customer satisfaction. Once downloaded and connected via a wireless technology such as Bluetooth, MultiPark resolves the issue of guests waiting for the valet to park or retrieve their vehicle before and after participating in festivities or when they are in a hurry to depart. The app can also locate available spots in parking garages for those who choose to self-park and pay within the app.

MultiPark's core features include a vast selection of restaurants, hotels and other hospitality establishments along with parking companies to assist with requests for valet services. Once the guest selects the business or parking facility and scans its assigned code through MultiPark, the valet will be alerted to get that specific vehicle and/or complete other requested services that are also offered at the establishment through the reservation.

For example: From their phone, a guest can send the request for operations to drop the car off before arriving. Valet will have everything prepared once the guest has arrived at the drop location and can hand the keys over to the representative and complete the drop off process in the application. When ready to leave, guests can simply send a notification to the valet operator to prepare the vehicle car ahead of time and send a reply with the estimated time until the car has arrived at the pick-up location. A reservation number will be assigned through the app and features capabilities such as being able to locate a space in a packed/popular lot (for parking lots and garages that do not offer valet services), parking at airports (alert valet before flight arrival) and can request a valet person to retrieve rental cars, instead of having to go to the rental counter.

MultiPark is a stand-alone app that can exist on other applications such as hotel booking apps, airline apps, restaurants apps and more and includes a multifactor authentication (face and finger recognition) to unlock the app before committing to services for additional security measures. MultiPark requires GPS location services for valet drop off and pick up locations, is available on App Store and Play Store for all smart device carriers and supports PCI, Apple Pay and can store cash in the app.

The disclosed MultiPark is the only mobile application of its kind that challenges and advances the process of using valet services. MultiPark is uniquely designed with different user roles, meaning there is a different portal view and permitted functions for the guest, valet, and administrator. MultiPark can be an essential app component for businesses that provide valet attendants in places such as hotels, rental companies, high-scale restaurants, high-security buildings, and airports.

The application will work just like the alarm application to alert the valet person and request other services such as a car wash, car detailing etc if available through the host facility. Options include sending a request to operations to drop a car off before arriving. Operations will be prepared once a driver arrives at the drop location. A driver hands keys over to a Representative and completes an electronic drop off application. When ready to pick up, the driver sends a notification to a valet person (operator) to prepare the car. The operator will reply with an estimated time for completion of the car wash and pick up. A reservation number and billing will be automatically handled and recorded per the reservation number.

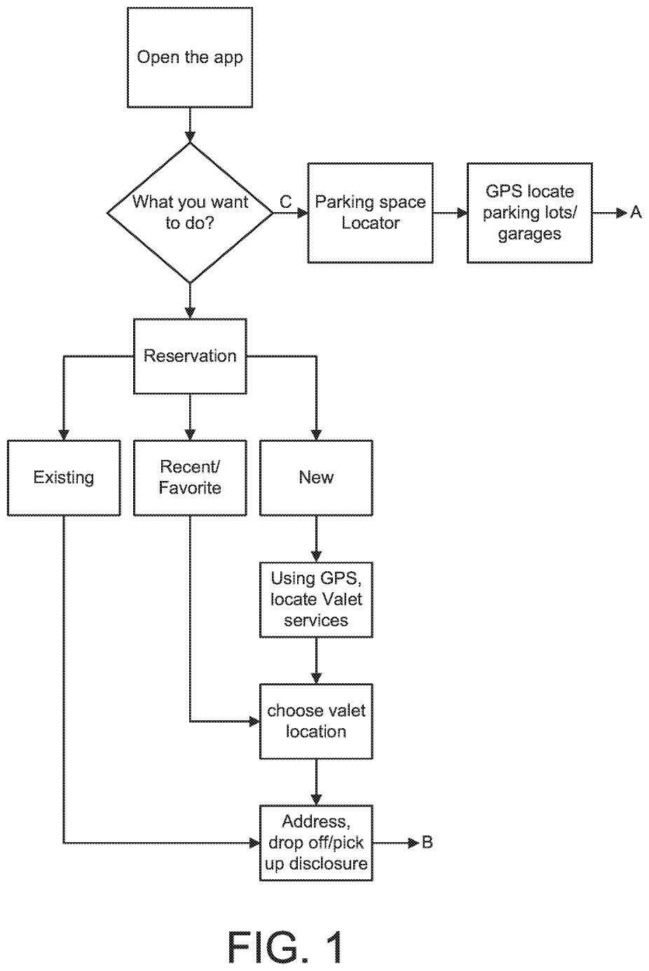

FIG. 1 depicts a first flow chart of the multipark valet parking application in accordance with the present invention. The app is opened, the user is queried and either a parking space is located with GPS (Global Positioning Satellite) or a reservation is handled as existing, new or favorite. If new, using GPS and a valet location, an address and time are determined. If recent or favorite, a valet is chosen and the address and time are determined. If an existing reservation then the address and time are determined.

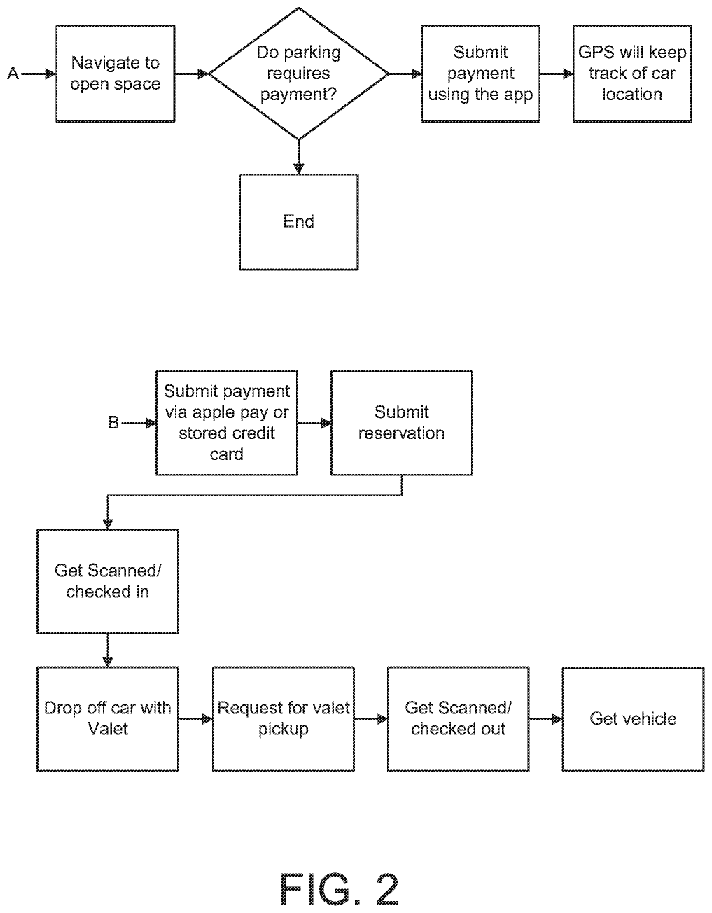

FIG. 2 depicts a second flow chart of the multipark valet parking application in accordance with the present invention. Picking up from point A of FIG. 1, an open space is navigated and depending on if a parking payment is required, a payment is made via the app and GPS is set up to track the car location. Picking up from point B of FIG. 1, a payment is made and a reservation is submitted, scanned or checked in and the car is dropped off with the valet with a request for pickup, scan out and possession of the vehicle.

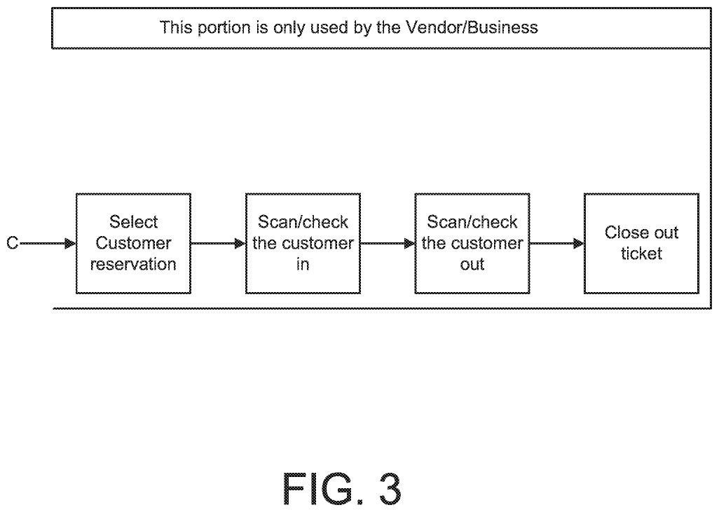

FIG. 3 depicts a third flow chart of the multipark valet parking application in accordance with the present invention. Picking up from point A of FIG. 1, this flow chart is only used by the vendor or business. It includes selecting a customer reservation, a customer scan or check in, a customer scan or check out and closing the ticket.

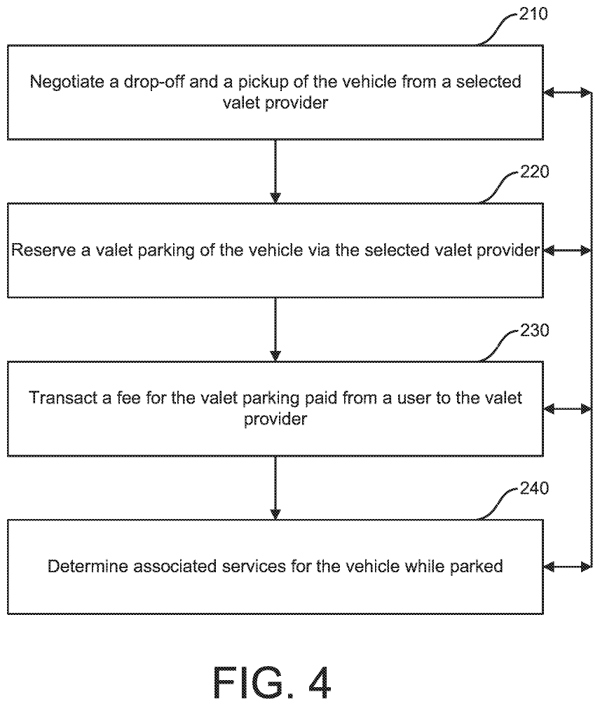

FIG. 4 is a flow chart of steps of a mobile application and a method for managing a valet parking of a vehicle per a multipark valet in accordance with a present embodiment of the disclosure. The steps include negotiating 210 a drop-off and a pickup of the vehicle from a selected valet provider, reserving 220 a valet parking of the vehicle via the selected provider, transacting 230 a fee for the valet parking paid from a user to the valet provider and determining 240 associated services for the vehicle while parked.

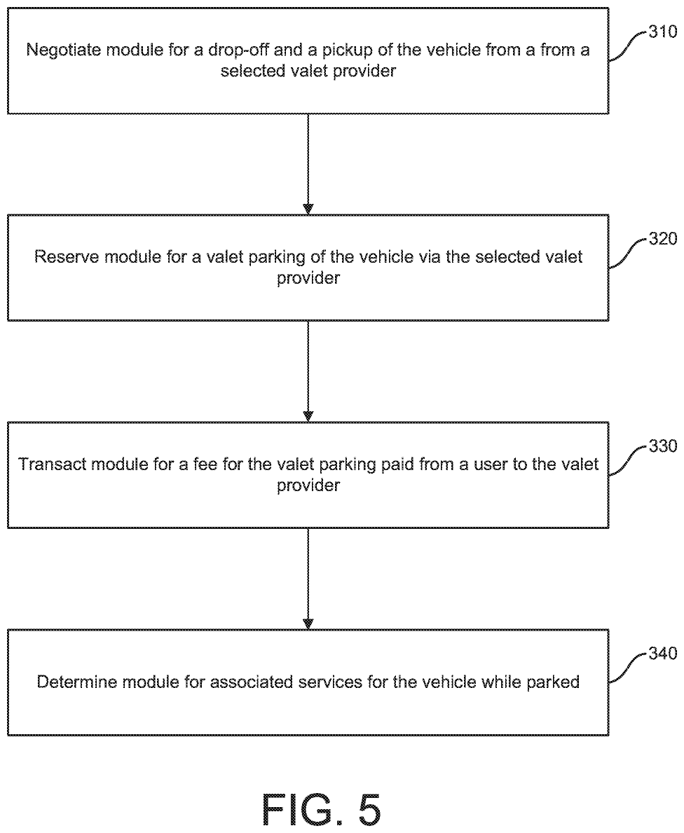

FIG. 5 is a block diagram of component modules for managing a valet parking of a vehicle per a multipark valet in accordance with an embodiment of the present disclosure. The component modules include a negotiating module 310 configured for a drop-off and a pickup of the vehicle from a selected valet provider, a reserving module 320 configured for a valet parking of the vehicle via the selected provider, a transacting module 330 configured for a fee for the valet parking paid from a user to the valet provider and a determining module 340 configured for associated services for the vehicle while parked.

Therefore, the following is provided to a customer user: a name of a valet provider, a location of the provider, a total parking space available at the provider and space open to the user, price per hour parking, price for delayed bookings, distance to the provider and media ratings for the provider. The disclosed application also includes the ability of a user to extend their booking with the parking provider and to delay their booking. When a requested time is completed and a customer does not extend their booking, the disclosed application will show the status as delayed booking. When the customer user arrives to pickup their automobile, a button on the booking page will be displayed to ‘complete booking,’ and allow the customer user to pay all required fees without the assistance of human intervention. The customer user's automobile is released from the parking spot at the vendor's lot via an exit gate by electronic communications circuits.

The present invention has been shown and described in what is considered to be the most practical and preferred embodiment thereof. It is recognized, however, that departures may be made there from within the scope of the invention and that obvious modifications will occur to a person skilled in the art.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A method of managing a valet service for a vehicle, the method comprising:
negotiating a drop-off and a pickup of the vehicle from a selected valet provider;
reserving a valet parking of the vehicle via the selected valet provider;
transacting a fee for the valet parking paid from a user to the valet provider; and
determining associated services for the vehicle while parked.

2. The method of claim 1, further comprising reserving a new valet reservation via a GPS (global positioning satellite) location of the vehicle, a location of a selected valet provider and a drop-off and pickup time disclosure.

3. The method of claim 1, further comprising reserving an existing valet reservation via modifying a drop-off and a pickup time.

4. The method of claim 1, further comprising reserving a favorite valet provider reservation via a predetermined GPS location of the vehicle, a predetermined location of a favorite valet provider and a predetermined drop-off and pickup time.

5. The method of claim 1, wherein determining associated services for the vehicle while parked further includes renting the vehicle to a third party for a time the vehicle is to be parked.

6. The method of claim 1, wherein determining associated services for the vehicle while parked further includes contracting for a car wash and a car detailing.

7. The method of claim 1, wherein determining associated services for the vehicle while parked further includes contracting a mechanical repair to the vehicle to be parked.

8. The method of claim 1, wherein the negotiating a drop-off and a pickup of the vehicle from a selected provider further includes receiving the vehicle a location distal from a location of the valet parking.

9. The method of claim 1, wherein negotiating a drop-off and a pickup of the vehicle from a selected provider further includes a pickup of the vehicle from a third party vehicle rental provider.

10. The method of claim 1, wherein the transacting a fee for the valet parking paid from a user to the valet provider further includes paying the fee via a third party payment service.

11. The method of claim 1, further comprising managing the valet service for the vehicle via a dedicated screen for the user, a dedicated screen for the valet provider and a dedicated screen for an administrator.

12. A computer program product comprising a computer readable storage medium having computer usable instruction codes executable to perform operations for managing a valet service for a vehicle, the operations of the computer program product comprising:
negotiating a drop-off and a pickup of the vehicle from a selected valet provider;
reserving a valet parking of the vehicle via the selected valet provider;
transacting a fee for the valet parking paid from a user to the valet provider; and
determining associated services for the vehicle while parked.

13. The computer program product of claim 12, further comprising reserving a new valet reservation via a GPS (global positioning satellite) location of the vehicle, a location of a selected valet provider and a drop-off and pickup time disclosure.

14. The computer program product of claim 12, further comprising reserving an existing valet reservation via modifying a drop-off and a pickup time.

15. The method of claim 12, wherein determining associated services for the vehicle while parked further includes renting the vehicle to a third party for a time the vehicle is to be parked.

16. The method of claim 12, wherein determining associated services for the vehicle while parked further includes contracting for a car wash and a car detailing.

17. The method of claim 12, wherein determining associated services for the vehicle while parked further includes contracting a mechanical repair to the car.

18. The method of claim 12, wherein the negotiating a drop-off and a pickup of the vehicle from a selected provider further includes receiving the vehicle a location distal from a location of the valet parking.

19. The method of claim 12, wherein negotiating a drop-off and a pickup of the vehicle from a selected provider further includes a pickup of the vehicle from a third party vehicle rental provider.

20. The method of claim 12, wherein transacting a fee for the valet parking paid from a user to the valet provider further includes paying the fee via a third party payment service.
